(19) United States
(12) Patent Application Publication
(10) Pub. No.: US 2006/0050680 A1
(43) Pub. Date: Mar. 9, 2006

(54) Method and system for providing authentication of a mobile terminal in a hybrid network for data and voice services

(75) Inventors: Ghassan Naim, Garland, TX (US); Jyoti Boppana, Plano, TX (US); Mahbubul Alam, McKinney, TX (US); Jianming Xu, Plano, TX (US)

Correspondence Address: HAYNES AND BOONE, LLP, 901 MAIN STREET, SUITE 3100, DALLAS, TX, 75202, US

(73) Assignee: Spatial Communications Technologies, Inc., Richardson, TX (US)

(21) Appl. No.: 10/511,863

(22) PCT Filed: Apr. 14, 2003
(86) PCT No.: PCT/US03/11573

§ 371 Date: Jul. 29, 2005

Related U.S. Application Data
(60) Provisional application No. 60/372,529, filed on Apr. 15, 2002.

(51) Int. Cl. H04M 1/68; H04M 1/66; H04M 3/16; H04L 12/66

(52) U.S. Cl. 370/352; 455/411

(57) ABSTRACT

The present disclosure provides a method and system for passing information required by a wireless procedure in a hybrid wireless network (300) before the procedure is invoked, the hybrid wireless network (300) having at least one radio access network (304, 306, 307) based on a first technology and a core network (302) based on a second technology. The hybrid network (300) implements a special mobile switching center (308) to be a “double agent” passing information between the mobile terminal (310, 320, 364) and entities in its core network (302). In the context of messaging, the message contents may be encoded, packaged, and decoded appropriately. The present disclosure does not introduce any changes to telecommunication standards such as the GSM and CDMA standards governing the messaging process.

### CROSS REFERENCE TO RELATED APPLICATIONS

The present application claims the benefit of the filing date of U.S. provisional patent application Ser. No. 60/372,529, attorney docket no. 29981.37, filed on 15 Apr. 2002.

### TECHNICAL FIELD

The invention relates in general to voice and data communications, and in particular to a system and method to conduct authentication in a hybrid wireless network.

### BACKGROUND INFORMATION

A typical wireless network is composed of two sub-networks: a Radio Access Network (RAN) which handles radio related issues such as assigning radio resources to a mobile terminal (or “mobile” in short) upon request for services, and a Core Network (CN) which links the mobile user to wireline networks. Current specifications of wireless networks require that the RAN and CN have the same wireless technology in order to provide wireless services. These networks may be referred to as “homogeneous networks.” For instance, a GSM mobile will only operate in a wireless network which its RAN and CN are both GSM wireless technology based. FIG. 1 illustrates a GSM wireless network 100 composed of a GSM RAN 102 and a GSM CN 104.

The GSM RAN 102 includes a GSM Mobile Station (MS) 106 that communicates to a GSM Base Station System (BSS) 108 through a GSM radio channel 110. The GSM BSS 108 includes a GSM Base Transceiver Station (BTS) 110 and GSM Base Station Controller (BSC) 112.

The GSM Core Network (CN) 104 includes a GSM Mobile Switching Center (MSC) 120 that is connected to the GSM BSC 112 as well as a GSM Gateway MSC (GMSC) 122 by using SS7 ISUP communications 124. The GSM GMSC 122 is also connected to the Public Switched Telephone Network (PSTN) 126 by using SS7 ISUP communications 124. In this figure, a telephone 128 is shown to be connected to the PSTN as an illustration of a calling/called party. In addition, a Serving General Packet Radio Service Node (GPRS) (SGSN) 130 is shown to also be connected to the GSM BSC 112. Moreover, a GSM Short Message Service Center (SMS-C) 132, a GSM Home Location Register (HLR) 134 and a GSM Authentication Center (AuC) 136 are all shown to be connected the GSM MSC 120 and the SGSN 130. Further, a GSM Service Control Point (SCP) 138 connects a GSM Billing System 140 to the GSM MSC 120 and the GSM HLR 134. The connection from the GSM Billing System 140 and the GSM MSC 120 utilizes IP. Additionally, a Packet Data Network (PDN) 142 is shown connected to the GSM CN 104 through a Gateway GPRS Node (GGSN) 144 utilizing IP communications.

A disadvantage of this configuration is that, given many wireless technologies that exist today and considering new ones being defined for the future, this is a serious limitation in the wireless service provision to deal with a situation in which a mobile compatible with one wireless technology moves into a wireless network of different technology. Such a configuration prevents the mobile from getting services and limits the mobile's geographical service area to networks that support a specific wireless technology. The same limitation applies to wireless networks that are CDMA wireless technology based.

FIG. 2 illustrates such a CDMA2000 based network 200. The CDMA2000 RAN 201 includes a CDMA2000 MS 202 connected to a CDMA2000 BSS 204 through a CDMA2000 BTS 206. The CDMA2000 BTS 206 is in turn connected to a CDMA2000 BSC 208, which connects to a Packet Control Function (PCF) 210.

The CDMA2000 CN 212 connects to the CDMA2000 RAN 201 by the CDMA2000 BSC 208 connecting to the CDMA200 MSC 214. The CDMA2000 MSC 214 is connected to an IS-41 SMS-C 216, an IS-41 HLR 218, an IS-41 AuC 220 and an IS-41 SCP 222. The IS-41 SCP 222 in turn is also connected to the IS-41 HLR 218 and a Store and Forward Service 224, which in turn is connected to an IS-41 Billing System 226. In addition, a Packet Data Serving Node (PDSN) 228 is connected to the PCF 210 of the CDMA2000 RAN 200 and a PDN 230. Moreover, the CDMA2000 MSC 214 connects the CDMA2000 CN 212 to the PSTN 232 and a phone 234.

A hybrid wireless network is a wireless network composed of a RAN and a CN of different technologies linked. FIG. 3 illustrates such a hybrid wireless network 300 including a GSM CN 302, which may be in communication with a GSM RAN 304 and/or a CDMA RAN 306. The RAN 304 and 306 communicate with the CN 302 through a Hybrid Mobile Switching Center (HMSC) 308. This network architecture presents a large advantage in deployment speed and cost reduction over the traditional homogeneous wireless networks discussed previously. One of the problems solved is to enable a mobile terminal in one of the RANs 304 or 306 and certain network entities in the CN 302 to exchange message contents without being obstructed by the differences in the technologies involved (e.g., message encoding and decoding schemes).

For example, in most wireless networks, wireless services are granted to a mobile after it is authenticated. This process is known as the authentication of a mobile. Different wireless technologies use different procedures and algorithms to perform such an authentication process. For instance, a CDMA mobile operating in a CDMA network generates authentication parameters which are quite different from those generated by a GSM mobile operating in a GSM network. There are currently no known solutions to provide authentication of a mobile operating in a hybrid wireless network.

What is needed, therefore, is a method and system for providing a solution to pass information and parameters to and from a mobile in a hybrid wireless network in which the RAN technology is CDMA2000 1xEV-DO before the authentication or other procedures requiring certain information from the network is invoked.

### SUMMARY OF THE INVENTION

The present disclosure provides a method and system for passing information required by a wireless procedure in a hybrid wireless network before the procedure is invoked, the hybrid wireless network having at least one radio access network based on a first technology and a core network based on a second technology. The hybrid network implements a special mobile switching center to be a “double agent” passing information between the mobile terminal and entities in its core network. In the context of messaging, the message contents may be encoded, packaged, and decoded appropriately. The present disclosure does not introduce any changes to telecommunication standards such as the GSM and CDMA standards governing the messaging process.

### BRIEF DESCRIPTION OF THE DRAWINGS

FIG. 1 illustrates a GSM wireless network architecture for providing services to a mobile user.

FIG. 2 illustrates a CDMA2000 wireless network architecture for providing services to a mobile user.

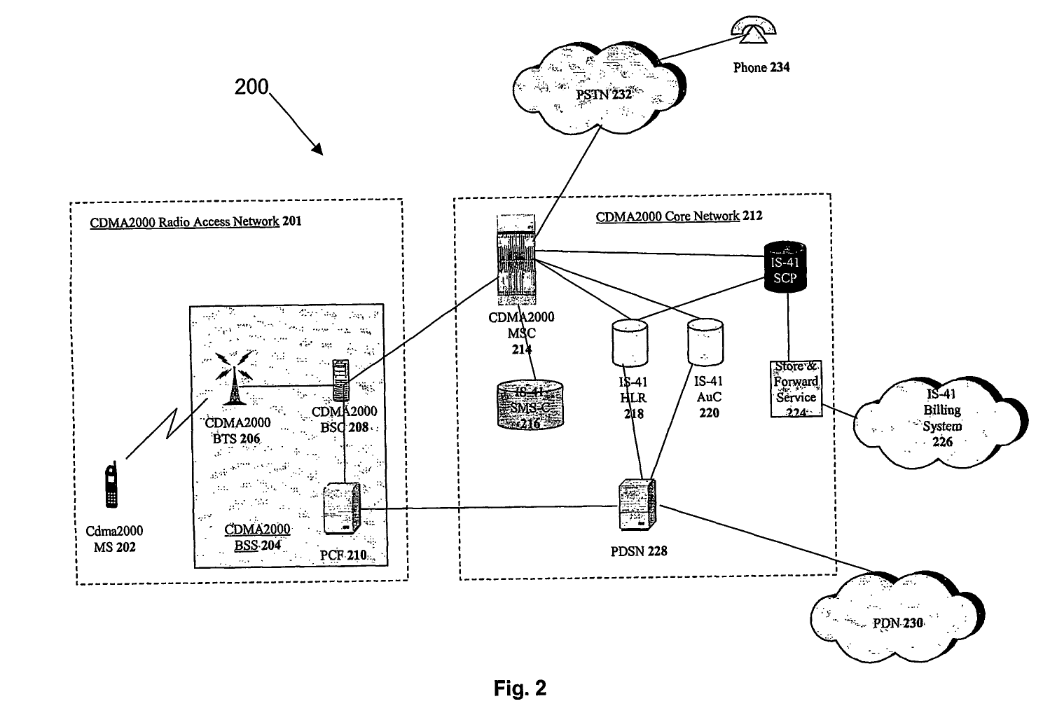

FIG. 3 illustrates a hybrid wireless network architecture with a hybrid Mobile Switching Center comprising a RAN using GSM, a RAN using CDMA2000 1xEV-DO, and a RAN using CDMA2000 1xRTT wireless technology, and a CN using GSM wireless technology.

FIG. 4 is a call flow diagram illustrating a successful authentication of a mobile operated in a CDMS-2000 1xEV-DO RAN and a GSM CN. This figure provides details complementary to FIG. 5.

FIG. 5 is a call flow diagram illustrating a failed authentication of a mobile operated in a CDMS2000 1xEV-DO RAN and a GSM CN. This failure results in denial of service.

FIG. 6 is a call flow diagram illustrating a failed authentication of a mobile operated in a CDMS2000 1xEV-DO RAN and a GSM CN. This failure does not result in denial of service.

FIG. 7 is a call flow diagram illustrating another failed authentication of a mobile operated in a CDMS2000 1xEV-DO RAN and a GSM CN. This failure does not result in denial of service.

FIG. 8 is a call flow diagram illustrating authentication when the mobile roams into a GSM RAN.

FIG. 9 is a call flow diagram illustrating authentication when the mobile roams into a CDMA2000 1xEV-DO RAN.

FIG. 10 is a call flow diagram illustrating authentication when the mobile roams into a GSM1x RAN.

### DETAILED DESCRIPTION OF THE INVENTION

For the purposes of the present disclosure, various acronyms are used, the definitions of which are listed below:
1xEv-DO Single carrier evolution, data only
1xRTT Single carrier evolution, radio transmission technology
ANSI-41 American National Standards Institute—Cellular Radio Telecommunications Intersystem Operations
AuC Authentication Center
BSC Base Station Center
BSS Base Station System
BTS Base station Transceiver System
CDMA Code Division Multiple Access
CHAP Challenge Handshake Authentication Protocol
CN Core Network
GMSC Gateway MSC
GSM Global System for Mobile communications
HLR Home Location Register
IP Internet Protocol
IMSI International Mobile Subscriber Identity
IS41 Wireless Network conforming to the IS41 standard
ISDN Integrated Services Digital Network
ISUP ISDN User Part (of SS7)
Kc Ciphering Key
Ki Subscriber authentication key
MSC Mobile Switching Center
PSTN Public Switch Telephone Network
RAN Radio Access Network
RAND RANDom Value
SCP Signalling Control Point
SMS-C Short Message Service Center
SRES Signed RESponse or Signature Response
SS7 Signaling System No. 7
T1 Digital communication line that uses time division multiplexing with an overall transmission rate of 1.544 million bits per second.
TCP/IP Transmission Control Protocol/Internet Protocol
VLR Visitor Location Register

Various aspects of the present invention provide a unique system and method for providing authentication of a mobile device in a hybrid wireless network. This patent application is based off of U.S. Provisional Patent 60/372,529 which is hereby incorporated by reference in its entirety. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

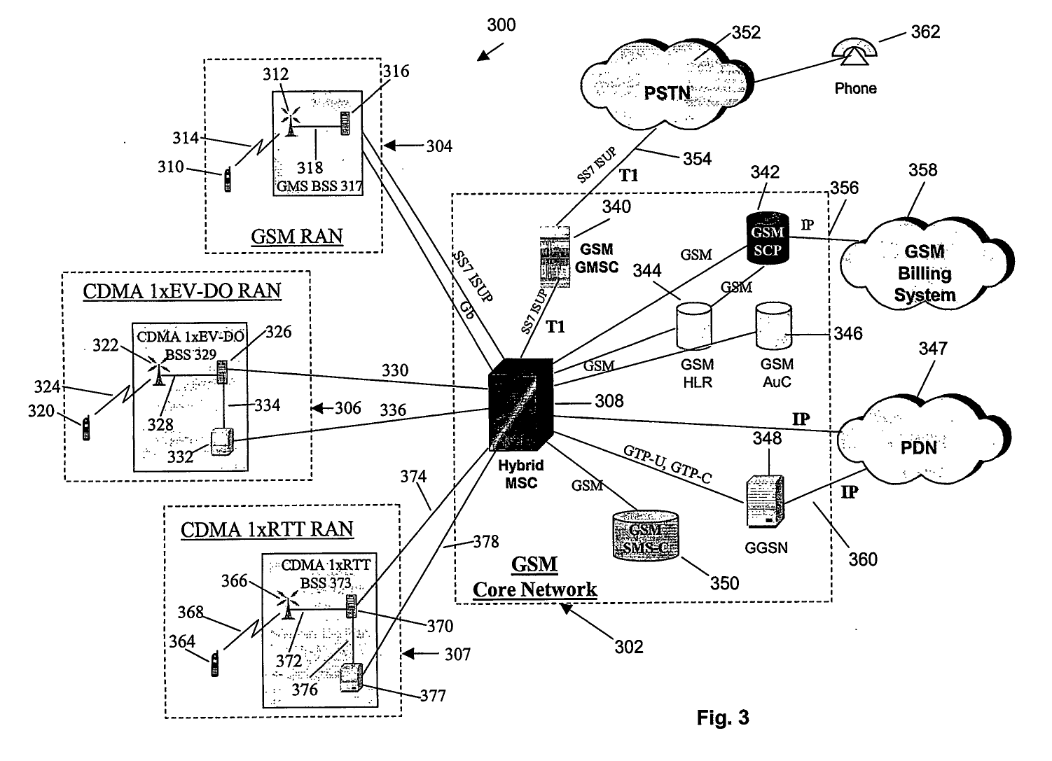

FIG. 3 illustrates a wireless network architecture utilizing a Hybrid Mobile Switching Center (HMSC) 308 to connect a CDMA2000 1xEV-DO RAN 306, a GSM RAN 304, and a CDMA2000 1xRTT RAN 307 to the GSM CN 302. In this example, the HMSC 308 has a centralized call control model for voice and packet data calls. This module allows the HMSC 308 to handle and keep track of all calls for a given mobile phone. In contrast, in a traditional GSM MSC or a CDMA MSC the call control for data and voice are located in different network entities. In this example embodiment, setting-up and controlling a voice or a data call for a mobile user is performed at the HMSC 308.

The example network architecture shown in FIG. 3 illustrates a hybrid network utilizing certain aspects of the present invention. The illustrative network provides both voice and packet data services to mobile stations in either of the two networks. For instance, in the GSM RAN 304, a GSM mobile unit 310 communicates with a GSM BTS 312 over a GSM radio link 314. The GSM BTS 312 typically communicates with a GSM BSC 316 using a wired link 318. The BTS 312 and BSC 316 comprise a base station system or BSS 317. In the illustrative embodiments, the HMSC 308 communicates with the GSM BSC 316 over a voice link using an SS7 ISUP protocol and over a data link using a Gb interface.

Similarly, in the CDMA2000 1xEV-DO RAN 306, a CDMA2000 mobile phone 320 communicates with a CDMA 1xEV-DO BTS 322 over a CDMA radio link 324. The CDMA 1xEV-DO BTS 322 typically communicates with a CDMA BSC 326 using a wired link 328. Typically, for voice communications, the CDMA BSC 326 communicates with the HMSC 308 over a link 330 using a variety of protocols, including A1, A2, A5, A8, and A9. The CDMA BSC 326 transfers data to a PCF 332 over a link 334 using A8 and A9 protocols. Thus, data is usually sent by the PCF 332 to the HMSC 308 over a link 336 using the A10 and A11 protocols.

Similarly, in the CDMA2000 1xRTT RAN 307, a CDMA2000 mobile phone 364 communicates with a CDMA 1xRTT BTS 366 over a CDMA radio link 368. The CDMA1xRTT BTS 366 typically communicates with a CDMA BSC 370 using a wired link 372. Typically, for voice communications, the CDMA BSC 370 communicates with the HMSC 308 over a link 374 using a variety of protocols, including A1, A2, A5, A8, and A9. The CDMA BSC 370 transfers data to a PCF 377 over a link 376 using A8 and A9 protocols. Thus, data is usually sent by the PCF 332 to the HMSC 308 over a link 378 using the A10 and A11 protocols.

If the core network is a GSM network, as in the illustrative network 300, the HMSC 308 communicates with the other GSM network components in much the same way a typical MSC would communicate with the GSM network components. For instance, the HMSC 308 may establish links with a GMSC 340, a SCP 342, an HLR 344, a AuC 346, a PDN 347, a GGSN 348, and/or a SMS-C 350. Similarly, the GMSC 340 may communicate with a PSTN 352 through a T1 link 354 using a SS7 ISUP protocol. The SCP 342 may establish a link 356 with a billing system 358, and the GGSN 348 may establish a link 360 with the PDN 347, where the links 356 and 360 uses an IP protocol. Thus, for each connection, FIG. 3 illustrates an example link and the corresponding communication protocol used to allow communication between typical network entities. As those skilled in the art would recognize, similar communication links may be established if the CN 302 were a CDMA network.

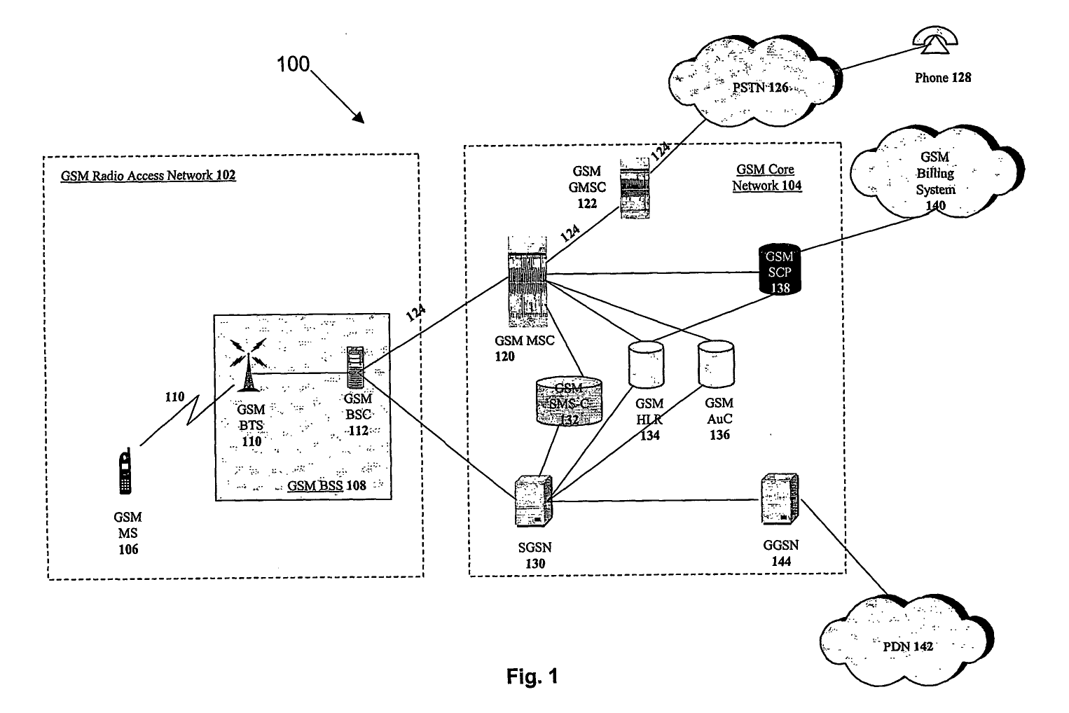

Thus, for calls established with the GSM mobile 310, the HMSC 308 acts like a GSM MSC 110 as depicted in FIG. 1. For calls established with the CMDA2000 mobile 320, the HMSC 308 links the CDMA RAN 304 to the GSM CN 302 by translating and mapping CDMA RAN messages initiated in the RAN 304 into GSM CN messages sent to the CN 302, and GSM messages initiated by the CN 302 into CDMA messages sent to the RAN 306.

The HMSC 308 can support voice and packet data call services from mobiles in any type of RAN to any other type of network. For instance the mobile 310 in the GSM RAN 304 can make a call to another mobile (not shown) operating in the CDMA RAN 306, a telephone 362 connected to the PSTN 352, or an entity as part of the PDN 347 and other networks that are not illustrated nor discussed in this disclosure for reasons of simplicity and clarity. The HMSC 308 is shown in communication with two RANs of different technologies, however as would be clear to one skilled in the art, the present invention also applies in situations where the HMSC 308 is in communication with one or more RANs of same technology.

Wireless services are granted to a mobile phone after the mobile phone is “authenticated.” Different wireless technologies use different procedures and algorithms to perform such an authentication process. For instance, the GSM mobile phone 310 operating in the GSM RAN 304 generates authentication parameters which are different from those generated by the CDMA mobile phone 320 operating in the CDMA RAN 306. Thus, one aspect of the present invention solves this problem by providing for a method of authentication of a mobile terminal in a hybrid wireless network, the hybrid wireless network having at least one radio access network (RAN) based on a first technology (e.g. CDMA) and a core network (CN) based on a second technology (e.g., GSM). Generally, the method comprises: requesting a registration of the mobile terminal from the RAN; passing predetermined parameters for the authentication by the CN through a HMSC to the mobile terminal using messages conforming to the first technology, the parameters conforming to the second technology; invoking an authentication process by the mobile terminal using the passed parameters; and informing the HMSC of the CN for the authentication of the mobile terminal.

A one-way hash function generates a fixed-length number output—called the hash value—given an arbitrary input. Secure one-way hash functions have the character that it is unfeasible to determine their input given their output. A key-dependent one-way hash function requires a key to calculate the hash value from the input. A typical use of a key dependent secure one-way hash function would be to verify the authenticity of a communicating entity. For instance, if entity A and entity B both know a private key and a key dependent secure one-way hash function, entity A can verify the authenticity of entity B by sending an arbitrary input to B and requesting entity B to return the hash value of this input calculated using the mutually known key dependent secure one-way hash function and the mutually known private key. Upon receiving the hash value from entity B, entity A calculates the hash value for itself and compares its hash value to the hash value from entity B. If the hash values are identical, entity A knows entity B is authentic, because only entity A and entity B know the private key (or others trusted by A and B to share the knowledge of the private key) and this is essential to calculating the correct hash value. If a spurious entity B′ were to attempt to pass itself off as the true entity B it would fail the authentication because it would not know the private key and hence could not calculate the appropriate hash value.

As is known in the art, a GSM authentication checks the validity of the subscribers subscriber identification module (SIM) card and then decides whether the mobile station should be allowed on a particular network. In a typical GSM network, the authentication process begins when a BSS/MSC/VLR sends the RAND and a GSM Cipering Key sequence (“Kc”), to the mobile unit. The SIM card in the mobile unit uses the RAND, its own private identifier Ki, and the A3 key-dependent secure one-way hash function to generate a signed response (SRES), which is then sent back to the BSS/MSC/VLR. The BSS/MSC/VLR compares the value of SRES received from the AuC with the value of SRES it has received from the mobile station. If the two values of SRES match, authentication is successful and the subscriber joins the network

This simple GSM authentication scenario does not cover all practical scenarios of authentication in a hybrid network given that the RAN technologies are not always the same as the CN technology. There are special cases to consider including roaming from a RAN of a first type of technology into a RAN of a second type of technology, roaming from a RAN of a second type of technology into a RAN of a first type of technology. Given that the CN only accepts GSM-based authentication parameters, a method is needed to pass the GSM-based parameters between the mobile and the CN over any type of RAN technology. In addition, the present invention introduces a new concept to achieve the appropriate goal. By doing so, scenarios as failed authentication using correct values of RAND (in which case service is denied), and failed authentication using incorrect values of RAND (in which retry procedures are invoked) are considered as well. All of these cases will be discussed in detail below.

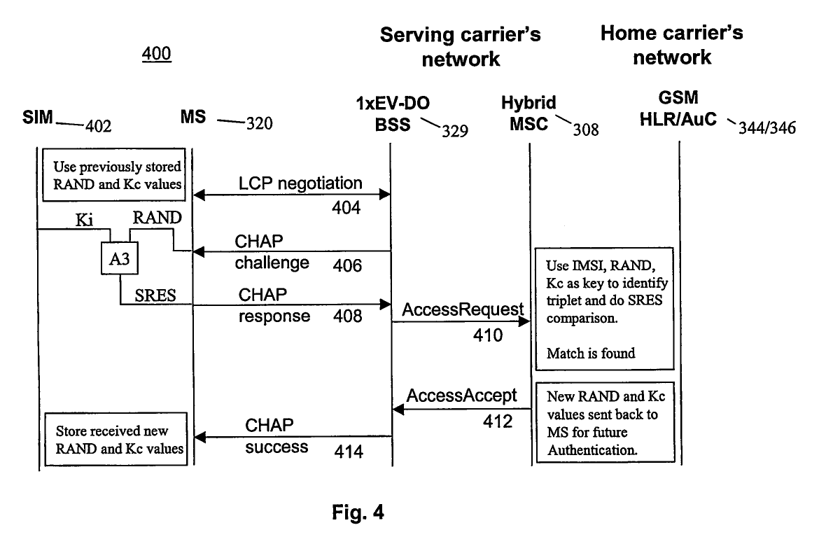

FIG. 4 illustrates an authentication call flow diagram 400 for a mobile in the hybrid network composed of a CDMA2000 1xEV-DO RAN 306 and a GSM CN 302. In the illustrative embodiment, the participants in the call flow are the Hybrid MSC 308, the 1xEV-DO BSS 329, the MS 320, and the SIM 402. While the GSM HLR 344 and GSM AuC 346 do not participate in this call flow, they do participate in related call flows and are shown in FIG. 4 for completeness. Step 404 represents a link control protocol (LCP) negotiation between the MS 320 and the 1xEV-DO BSS 329. A LCP is used to establish, configure, and test the link communication. Establishment of the link involves each end of the link—the MS 320 and the BSS 329—negotiating various link options. In step 406 the 1xEV-DO BSS 329 sends a message to the MS 320 to initiate authentication (e.g., in the form of a challenge handshake authentication protocol (CHAP) challenge message). The SIM 402 may use previously stored values of RAND and Kc as well as the internally stored value of Ki in the A3 function to calculate the SRES. Note that in GSM standard, Kc and RAND are sent from the CN to the mobile upon authentication request. In one aspect of the present invention, a new concept is introduced where the RAND and Kc are sent to the mobile during a previous authentication procedure. In step 408 the MS 320 sends a message encapsulating authentication parameters including the value of RAND, the international mobile subscriber identity associated with the MS 320, the calculated SRES value, and the value of Kc to the 1xEV-DO BSS 329 (e.g., in the form of a CHAP response message encapsulating parameters including name=‘GSMIMSI@operator.com’ and CHAP Password=‘SRES&RAND&Kc’). In step 410 the 1xEV-DO BSS 329 sends a message encapsulating authentication parameters including the value of RAND, the international mobile subscriber identity associated with the MS 320, the calculated SRES value, and the value of Kc to the Hybrid MSC 308 (e.g., in the form of an Access Request message encapsulating parameters including username=‘GSM IMSI’ and Passwd=‘SRES & RAND & Kc’). The Hybrid MSC 308 may use the IMSI, RAND, and Kc parameters to index into a local database to retrieve a stored SRES value to compare with the SRES parameter which is passed in from the 1xEV-DO BSS 329. If the Hybrid MSC 308 SRES value agrees with the passed in value of SRES, the MS 320 is authenticated. In step 412 the Hybrid MSC 308 sends a message encapsulating new values of RAND and Kc to the 1xEV-DO 329 (e.g. in the form of an Access Accept message). In step 414 the 1xEV-DO BSS 329 sends a message encapsulating new values of RAND and Kc to the MS 320 (e.g. in the form of a CHAP success message encapsulating new values of RAND and Kc). The MS 320 may store new values of RAND and Kc for future use in authentication procedures.

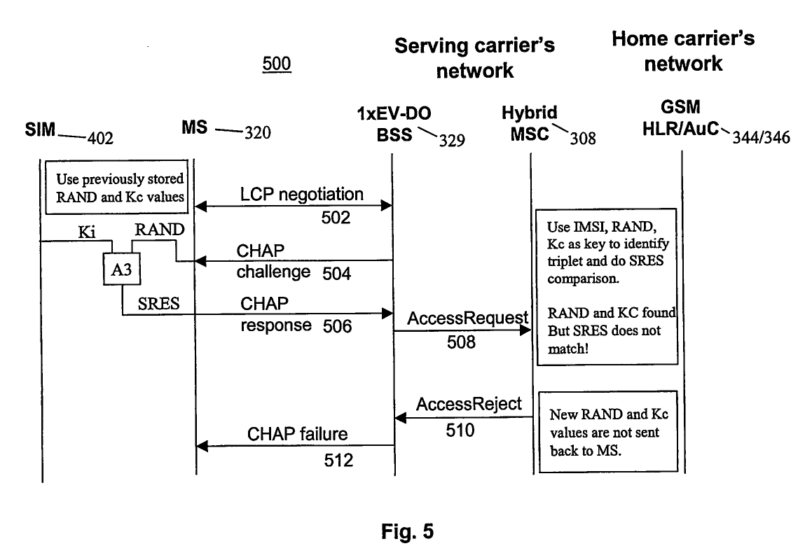

Turning to FIG. 5, a failed authentication operation is depicted. Step 502 is the LCP negotiation between the MS 320 and the 1xEV-DO BSS 329. In step 504 the 1xEV-DO BSS 329 sends a message to the MS 320 to initiate authentication (e.g., in the form of a challenge handshake authentication protocol (CHAP) challenge message). The SIM 402 uses previously stored values of RAND and Kc as well as the internally stored value of Ki in the A3 function to calculate SRES. In step 506 the MS 320 sends a message encapsulating authentication parameters including the value of RAND, the international mobile subscriber identity associated with the MS 320, the SRES value the SIM 402 calculated, and the value of Kc to the 1xEV-DO BSS 329 (e.g., in the form of a CHAP response message encapsulating parameters including name=‘GSMIMSI@operator.com’ and CHAP Password=‘SRES&RAND&Kc’). In step 508 the 1xEV-DO BSS 329 sends a message encapsulating authentication parameters including the value of RAND, the international mobile subscriber identity associated with the MS 320, the SRES value the SIM 402 calculated, and the value of Kc to the Hybrid MSC 308 (e.g., in the form of an Access Request message encapsulating parameters including username=‘GSM IMSI’ and Passwd=‘SRES & RAND & Kc’). The Hybrid MSC 308 may use the IMSI, RAND, and Kc parameters to index into a local database to retrieve a stored SRES value to compare with the SRES parameter which is passed in from the 1xEV-DO BSS 329. In this case the Hybrid MSC 308 SRES value disagrees with the passed in value of SRES, and the MS 320 is not authenticated. In step 510 the Hybrid MSC 308 sends a message to the 1xEV-DO 329 (e.g., in the form of an Access Reject message). In step 512 the 1xEV-DO BSS 329 sends a message denying access to the MS 320 (e.g., in the form of a CHAP failure message). Note that no new RAND and Kc values are passed from the Hybrid MSC 308 back to the MS 320.

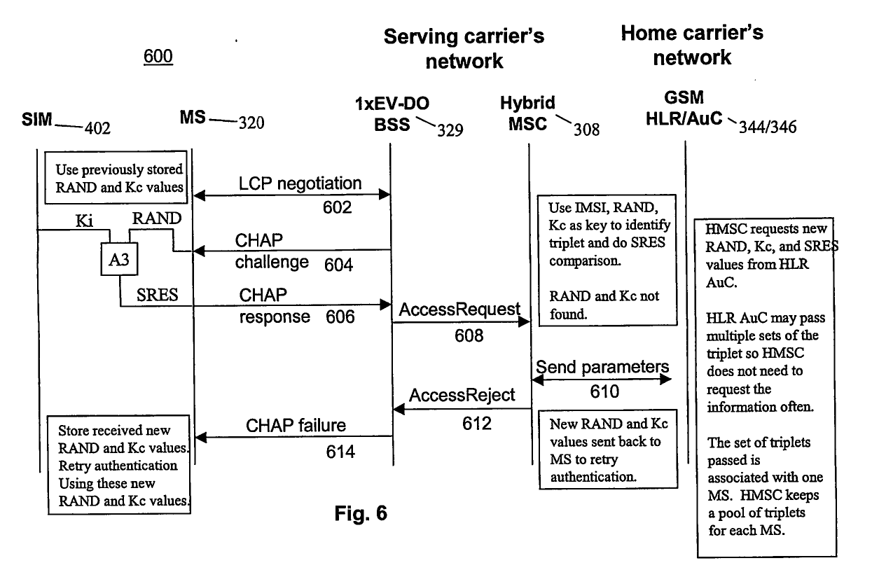

Turning now to FIG. 6, a failed authentication operation is depicted. Step 602 is the LCP negotiation between the MS 320 and the 1xEV-DO BSS 329. In step 604 the 1xEV-DO BSS 329 sends a message to the MS 320 to initiate authentication (e.g., in the form of a challenge handshake authentication protocol (CHAP) challenge message). The SIM 402 uses previously stored values of RAND and Kc as well as the internally stored value of Ki in the A3 function to calculate the SRES. In step 606 the MS 320 sends a message encapsulating authentication parameters including the value of RAND, the international mobile subscriber identity associated with the MS 320, the SRES value the SIM 402 calculated, and the value of Kc to the 1xEV-DO BSS 329 (e.g., in the form of a CHAP response message encapsulating parameters including name=‘GSMIMSI@operator.com’ and CHAP Password=‘SRES&RAND&Kc’). In step 608 the 1xEV-DO BSS 329 sends a message encapsulating authentication parameters including the value of RAND, the international mobile subscriber identity associated with the MS 320, the SRES value the SIM 402 calculated, and the value of Kc to the Hybrid MSC 308 (e.g., in the form of an Access Request message encapsulating parameters including username=‘GSM IMSI’ and Passwd=‘SRES & RAND & Kc’). The Hybrid MSC 308 may use the IMSI, RAND, and Kc parameters to index into a local database to retrieve a stored SRES value to compare with the SRES parameter which is passed in from the 1xEV-DO BSS 329. In the scenario illustrated in FIG. 6 the values RAND and Kc are not found. In step 610 the Hybrid MSC fetches one or more new RAND, Kc, and SRES value triplets from the GSM HLR 344 and AuC 346. In step 612 the Hybrid MSC 308 sends a message encapsulating new values of RAND and Kc to the 1xEV-DO 329 (e.g., in the form of an Access Reject message encapsulating new values of RAND and Kc). In step 614 the 1xEV-DO BSS 329 sends a message encapsulating new values of RAND and Kc to the MS 320 (e.g., in the form of a CHAP failure message encapsulating new values of RAND and Kc). The MS 320 may store new values of RAND and Kc for future use in authentication procedures. The MS 320 will retry authentication with the new RAND and Kc values.

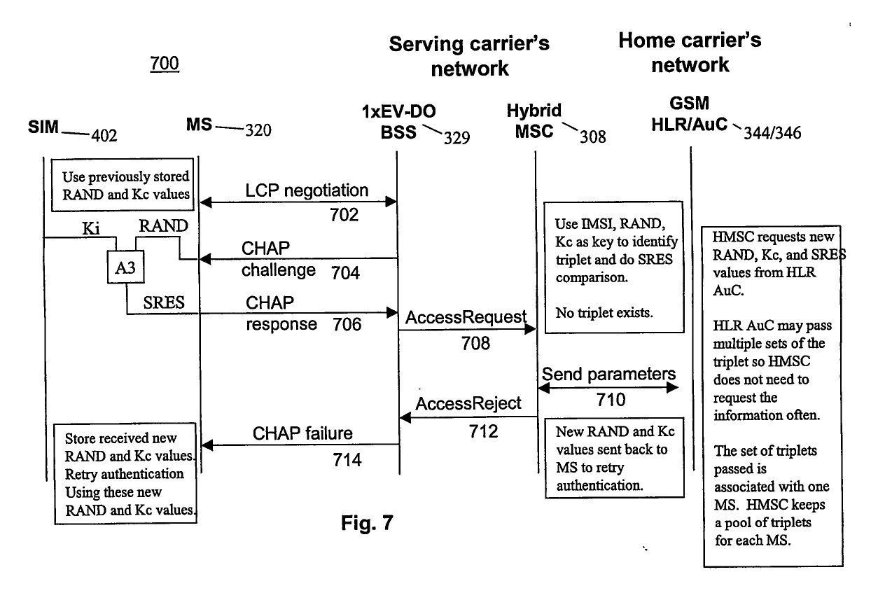

Turning now to FIG. 7, a failed authentication operation is depicted. Step 702 is the LCP negotiation between the MS 320 and the 1xEV-DO BSS 329. In step 704 the 1xEV-DO BSS 329 sends a message to the MS 320 to initiate authentication (e.g., in the form of a challenge handshake authentication protocol (CHAP) challenge message). The SIM 402 uses previously stored values of RAND and Kc as well as the internally stored value of Ki in the A3 function to calculate SRES. In step 706 the MS 320 sends a message encapsulating authentication parameters including the value of RAND, the international mobile subscriber identity associated with the MS 320, the SRES value the SIM 402 calculated, and the value of Kc to the 1xEV-DO BSS 329 (e.g., in the form of a CHAP response message encapsulating parameters including name=‘GSMIMSI@operator.com’ and CHAP Password=‘SRES&RAND&Kc’). In step 708 the 1xEV-DO BSS 329 sends a message encapsulating authentication parameters including the value of RAND, the international mobile subscriber identity associated with the MS 320, the SRES value the SIM 402 calculated, and the value of Kc to the Hybrid MSC 308 (e.g., in the form of an Access Request message encapsulating parameters including username=‘GSM IMSI’ and Passwd=‘SRES & RAND & Kc’). The Hybrid MSC 308 may use the IMSI, RAND, and Kc parameters to index into a local database to retrieve a stored SRES value to compare with the SRES parameter which is passed in from the 1xEV-DO BSS 329. In the scenario illustrated in FIG. 7 there are no RAND, Kc, and SRES triplet stored in the Hybrid MSC 308. In step 710 the Hybrid MSC fetches one or more new RAND, Kc, and SRES value triplets from the GSM HLR 344 and AuC 346. In step 712 the Hybrid MSC 308 sends a message encapsulating new values of RAND and Kc to the 1xEV-DO 329 (e.g., in the form of an Access Reject message encapsulating new values of RAND and Kc). In step 714 the 1xEV-DO BSS 329 sends a message encapsulating new values of RAND and Kc to the MS 320 (e.g., in the form of a CHAP failure message encapsulating new values of RAND and Kc). The MS 320 may store new values of RAND and Kc for future use in authentication procedures. The MS 320 will retry authentication with the new RAND and Kc values.

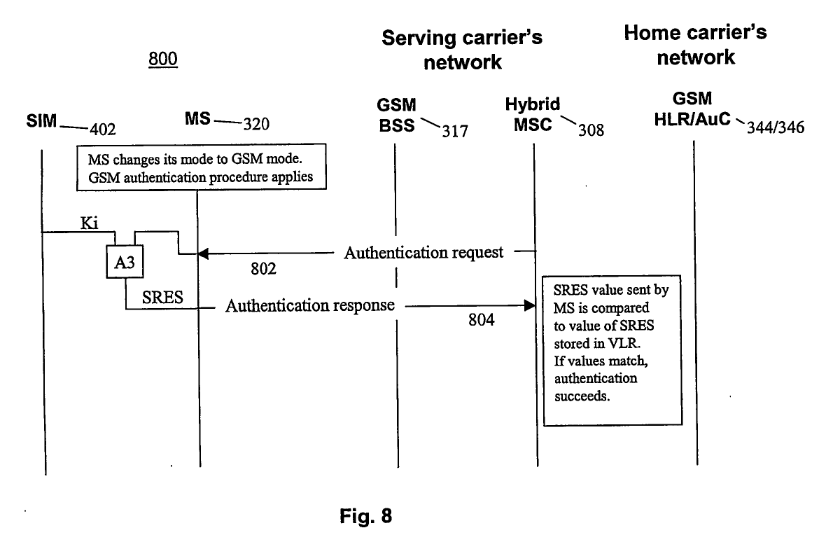

Turning now to FIG. 8 we have an illustrative call flow for mobile authentication when the mobile roams into a GSM RAN. In this case the MS 320 changes mode to GSM mode. Now the standard GSM authentication procedure applies. In step 802 the Hybrid MSC 308 sends an authentication request message bearing RAND and Kc parameters to the GSM BSS 317. The GSM BSS 317 forwards this authentication request to the MS 320 The SIM 402 uses the RAND and Kc which were received by the MS 320 in the authentication request message as well as the internally stored value of Ki in the A3 function to calculate the SRES. The MS 320 sends an authentication response message bearing the calculated SRES value to the GSM BSS 317. The GSM BSS 317 forwards this authentication response message to the Hybrid MSC 308. The SRES value sent by the MS 320 is compared to the SRES value stored in the VLR at the Hybrid MSC 308. If the values match, authentication succeeds.

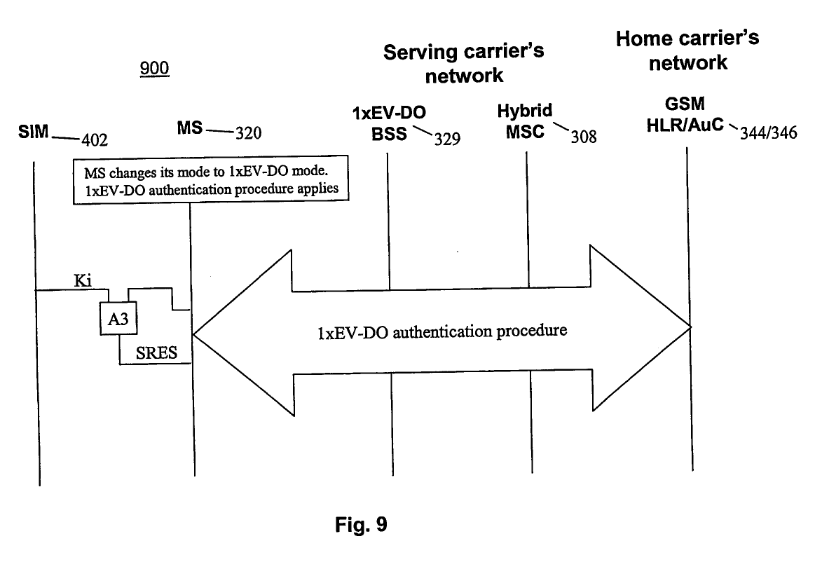

Turning now to FIG. 9 we have an illustrative call flow for mobile authentication when the mobile roams into a 1xEV-DO RAN. In this case the mobile changes mode to 1xEV-DO mode, and then the authentication scenarios are similar to those already described by FIG. 4 through FIG. 7.

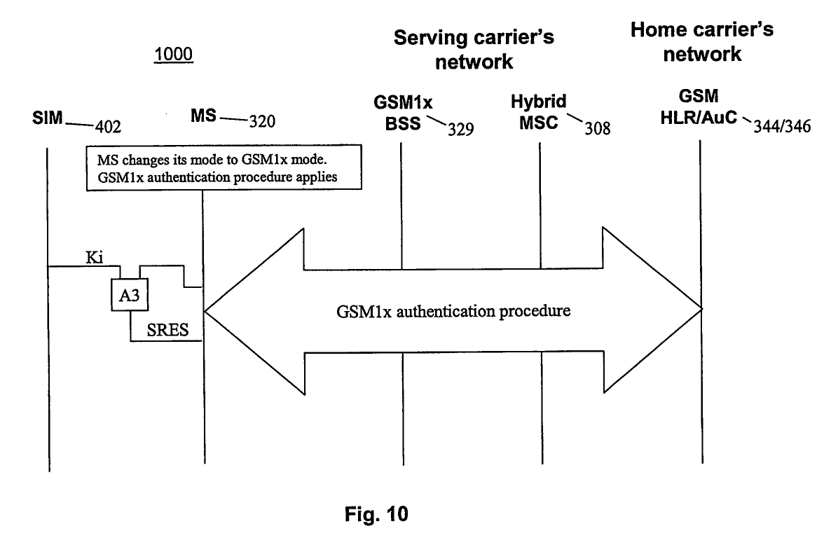

Turning now to FIG. 10 an illustrative call flow is shown for mobile authentication when the mobile roams into a GSM1x RAN. GSM1x is a later version of GSM. In this case the mobile changes mode to GSM1x mode, and then the authentication proceeds according to standard GSM1x authentication scenarios.

In the present disclosure, the messages CHAP Response and Access Request are used to carry the necessary GSM information from the mobile to the network, and the message Access Accept, Access Reject, CHAP Success, and CHAP Failure are used to carry the information from the network to the mobile. In this patent application “pass-through messages means that the information encapsulated in these messages is carried transparently over the 1xEv-DO RAN. That is, none of the entities in the RAN act upon the information encapsulated in these messages, but simply forward them to the next entity until the mobile is reached or the HMSC is reached. In this patent application “encapsulate” means to intercalate information within a message, thereby to make the message carry information additional to the mere message type. In this patent application the term “packaging” may be used in the same sense defined above for the term “encapsulate,” and hence “packaging” and “encapsulating” may substitute for one another from place to place in this patent application.

The above disclosure provides many different embodiments, or examples, for implementing the disclosure. However, specific examples, and processes are described to help clarify the disclosure. These are, of course, merely examples and are not intended to limit the disclosure from that described in the claims. For instance, even if a CHAP Challenge message and procedure is used to describe the disclosure, the present disclosure still applies to any scenario or event that can occur in the wireless network and that causes the mobile or the network to initiate the authentication procedure.

Additionally, although a dual-mode mobile that can support voice and packet data is used to describe the disclosure, the present disclosure still applies to any multi-mode mobile. Additionally, GSM and CDMA are used as examples to describe the disclosure. It is understood that the disclosure still applies to any authentication scenario between two wireless networks that have the same CN technology but different RAN technologies.

The present disclosure as described above thus provides an economical method and system for providing an authentication solution to a multi-mode mobile operating in a hybrid network. The present disclosure does not introduce any changes to the GSM and CDMA standards that define the protocols used to communicate between all network entities. Also, the disclosure does not introduce any change to any entity between the HMSC and the mobile.

In addition, the present disclosure provides a cost effective solution given that it does not introduce any change to existing architectures in the RAN and CN. This is a significant advantage for a network operator or service provider because there is no need for investing capital in upgrading existing equipment. The migration of the services to be supported by the new network can be achieved in a much shorter time and at a lower cost. The method and system described in the present disclosure increases the wireless coverage to operators exponentially, speeds up deployment phase, minimizes deployment expenses, eliminates core network operation expenses and provides higher quality of service for the mobile end user, therefore attracting more subscribers to operators.

Also, the present disclosure presents a solution to deploy a new radio technology into wireless networks without introducing any change to the core network. This creates a huge advantage for network operators that looking to expand their wireless service coverage of a new radio technology. The present disclosure needs very low cost and short deployment time considering that the core network does not have to be changed whatsoever. By deploying a new radio technology over an existing core network of existing technologies, major advantages are achieved at the radio access network such as higher bit rates. Other advantages are higher network capacity and increase in spectrum efficiency on the radio which leads to the ability of supporting larger number of subscribers and introducing better quality of service to the mobile user end. This means providing larger service coverage area and higher revenues to network operators.

Moreover, because no changes are made to the existing core network, the present disclosure allows the delivery of all existing CN services to any mobile in its serving area.

It will also be understood by those skilled in the art that one or more (including all) of the elements/steps of the present disclosure may be implemented using software and hardware to develop the HMSC, which will then be deployed in a wireless network at appropriate locations with the proper connections.

Furthermore, while the disclosure has been particularly shown and described with reference to the preferred embodiment thereof, it will be understood by those skilled in the art that various changes in form and detail may be made therein without departing from the spirit and scope of the disclosure, as set forth in the following claims.

What is claimed is:

1. A method for transmitting message content required by a wireless procedure in a hybrid wireless network before the procedure is invoked, the hybrid wireless network having at least one radio access network based on a first technology and a core network based on a second technology, the radio access network and core network having different encoding and decoding schemes for the message contents, the method comprising:
sending message contents in a message of a first type from a network entity in the core network to a hybrid mobile switching center using a first encoding scheme;
extracting the encoded message contents by the hybrid mobile switching center;
packaging the extracted message content in a second message of a second type readable by a mobile terminal in the radio access network;
extracting the message contents from the second message by the mobile terminal; and
decoding the message contents encoded by the first encoding scheme,
wherein the hybrid mobile switching center is capable of communicating to both the mobile terminal and the core network with messages conforming to either the first or second technologies and wherein the mobile terminal is a dual mode terminal operable with either the first or the second technologies.

2. A method for transmitting message content required by a wireless procedure in a hybrid wireless network before the procedure is invoked in a hybrid wireless network, the hybrid wireless network having at least one radio access network based on a first technology and a core network based on a second technology, the radio access network and core network having different encoding and decoding schemes for the message contents, the method comprising:
sending message contents in a message of a first type from a mobile terminal in the radio access network to a hybrid mobile switching center in the core network using a first encoding scheme;
extracting the encoded message contents by the hybrid mobile switching center;
packaging the extracted message content in a second message of a second type readable by a predetermined network entity in the core network;
extracting the message contents from the second message by the network entity; and
decoding the message contents encoded by the first encoding scheme,
wherein the hybrid mobile switching center is capable of communicating to both the mobile terminal and the core network with messages conforming to either the first or second technologies and wherein the mobile terminal is a dual mode terminal operable with either the first or the second technologies.

3. A method for providing authentication of a mobile terminal in a hybrid wireless network, the hybrid wireless network having at least one radio access network based on a first technology and a core network based on a second technology, the method comprising:
sending an initiating authentication message to a mobile unit,
receiving a signature response, a random value, a ciphering key in a first message compatible with the first technology,
sending the signature response, the random value, the ciphering key in a form compatible with the second technology,
receiving an authentication indication in a message compatible with the second technology,
sending the random value and the ciphering key in an authentication message compatible with the first technology.

4. The method of claim 3 wherein the initiating authentication message further comprises sending a challenge message.

5. The method of claim 3 wherein the receiving a signature response, a random value, a ciphering key in a first message compatible with the first technology further comprises receiving a response to the challenge message.

6. The method of claim 3 wherein the sending the signature response, the random value, the ciphering key in a form compatible with the second technology further comprises sending an access request message.

7. The method of claim 3 wherein the receiving an authentication indication in a message compatible with the second technology further comprises receiving a access accept message.

8. The method of claim 3 wherein the receiving an authentication indication in a message compatible with the second technology further comprises receiving a access reject message.

9. The method of claim 3 wherein the sending the random value and the ciphering key in an authentication message compatible with the first technology further comprises sending a challenge success message.

10. The method of claim 3 wherein the sending the random value and the ciphering key in an authentication message compatible with the first technology further comprises sending a challenge failure message.

11. The method of claim 6 further comprising using the international mobile identity number, the random number, and the ciphering key to perform a signature response comparison.

12. The method of claim 7 further comprising requesting a new signature response, a new random value, and a new ciphering key.

13. A method for providing authentication of a mobile terminal in a hybrid wireless network, the hybrid wireless network having at least one radio access network based on a first technology and a core network based on a second technology, the method comprising:
receiving parameters in a message compatible with the first technology,
comparing the signature response using the international mobile identity number, the random number, and the ciphering key, and
sending new parameters for authentication during a future authentication process.

14. The method of claim 13 wherein the receiving parameters further comprises receiving a signature response, a random number, and a ciphering key.

15. The method of claim 13 wherein the sending new parameters for authentication further comprises a new random number and a new ciphering key.

16. A method for providing authentication of a mobile terminal in a hybrid wireless network, the hybrid wireless network having at least one radio access network based on a first technology and a core network based on a second technology, the method comprising:
requesting a handshake authentication protocol challenge of the mobile terminal from the radio access network;
invoking an authentication process using stored parameters from a previous authentication process;
passing predetermined parameters for the authentication by the core network through a hybrid mobile switching center to the mobile terminal using messages conforming to the first technology, the parameters conforming to the second technology;
invoking an authentication process by the mobile terminal using the passed parameters during the current authentication process;
informing the hybrid mobile switching center of the core network for the authentication of the mobile terminal,
wherein the hybrid mobile switching center is capable of communicating to both the mobile terminal and the core network with messages conforming to either the first or second technologies.

17. The method of claim 16 wherein:
the radio access network supports the CDMA2000 1xEV-DO standard and
the core network supports the global system for mobile communications standard.
